(19) United States
(12) Patent Application Publication
(10) Pub. No.: US 2008/0276268 A1
(43) Pub. Date: Nov. 6, 2008

(54) System and Method for Content Insertion

(75) Inventors: Ofer Harpak, Kiryat-Tivon (IL); Daniel Bron-Holc, Ramat-Hasharon (IL)

Correspondence Address: RECHES PATENTS, 211 NORTH UNION STREET, SUITE 100, ALEXANDRIA, VA, 22314, US

(73) Assignee: WINET-WORKS INC., Herzeliya (IL)

(21) Appl. No.: 11/915,860

(22) PCT Filed: May 31, 2006
(86) PCT No.: PCT/IL06/00632

§ 371 Date: Nov. 29, 2007

(30) Foreign Application Priority Data
May 31, 2005 (US) 60/686143

(51) Int. Cl. H04N 7/025

(52) U.S. Cl. 725/32

(57) ABSTRACT

A device and method for local content insertion. The method includes: receiving multiple programs over a satellite link (220); determining whether to perform a local content insertion such as to insert a local content entity to a selected program being outputted by an end user device (240); inserting the local content entity in response to the determination (250); and providing the selected program that comprises the inserted local content entity to the end user device.

### BACKGROUND OF THE INVENTION

Modern television network include either satellite based networks or cable based networks.

Cable based network facilitate local content insertion by utilizing components that are located in local hubs, central hubs and headends.

A typical local content insertion device usually receives a multiple-program multiplex (such as a Multiple Program Transport Stream) and uses its relatively powerful computerized resources to insert local (or even personalized) content entities (such as advertisements) into multiple programs.

Typically a local content insertion cable unit services a relatively limited amount of end users.

Satellite based networks usually use a single satellite for transmission of content to a very large number of end users. The end users usually have a domestic satellite dish that is connected to a receiver and a set top box.

Accordingly, satellite based networks are not able to perform local content insertion.

WiMAX (World Interoperability for Microwave access) is the name associated with a group of 802.16 IEEE standards as well as related standards such as 802.18, 802.20 AND 802.22. WiMAX allows broadband communication using terrestrial wireless links that uses licensed or unlicensed frequencies.

Part 16 of the 802.16 IEEE standard defines an air interface for fixed broadband wireless access systems. It defines a complex MAC and PHY layers that allow a WiMAX transmitter to perform many modulations, and to perform multiple carrier transmissions. The MAC layer can dynamically grant access to a shared wireless medium. The MAC layer chip is usually connected to an RF chip that in turn is connected to a microwave antenna.

WiMAX technology is adapted to use terrestrial links for wirelessly conveying information between base stations and mobile or stationary subscriber devices.

A typical WiMAX device can receive data, audio and video and provide it to an end user component.

There is a need to allow local content insertion in satellite based networks.

### SUMMARY

A system that includes: a processor connected to a parser, wherein the parser is adapted to parse a selected program out of a multiplex of programs provided to the system over a satellite reception path; wherein the processor is adapted to determine whether to insert local content to the selected program and in response to the determination inserts the local content; wherein the system is further adapted to provide the selected program that includes the local content to an end user system.

Conveniently, the system includes a local content storage unit adapted to store a limited amount of local content.

Conveniently, the system is adapted to receive the local content over a link that differs from the satellite link.

Conveniently, the system is adapted to be coupled to a WiMax antenna and is adapted to receive local content from the WiMax antenna.

Conveniently, the system is adapted to receive information representing a program being outputted from an end-user system and in response select this outputted program as the selected system.

Conveniently, the system includes a modulator adapted to send to a limited number of end user systems a multiplex of programs that includes the selected program and the inserted local content in a format the corresponds to a format of signals provided by a satellite that is being received by the satellite reception path.

Conveniently, the system is adapted to store local content included within a dedicated satellite program.

Conveniently, the system is adapted to store local content included within a dedicated satellite program that is associated with an area indication.

Conveniently, the system is further adapted to exchange data over a wired network.

Conveniently, the system includes a satellite reception path and a terrestrial antenna.

A method that includes: receiving multiple programs over a satellite link; determining whether to perform a local content insertion such as to insert a local content entity to a selected program being outputted by an end user device; inserting the local content entity in response to the determination; and providing the selected program that includes the inserted local content entity to the end user device.

Conveniently, the method further includes receiving the local content entity and storing the local content entity.

Conveniently, the method further includes receiving the local content entity over a link that differs from a satellite reception link.

Conveniently, the method further including receiving the local content entity from a WiMax antenna.

Conveniently, the method wherein the method includes formatting the selected program that includes the inserted local content according in a format that corresponds to a format of the selected program as being transmitted over the satellite link.

Conveniently, the method further includes storing the local content entity that is included within a dedicated satellite program.

Conveniently, the method further includes storing the local content entity that is included within a dedicated satellite program.

Conveniently, the method further includes storing the local content entity that is included within a dedicated satellite program that is associated with an area indication.

Conveniently, the method further includes exchanging data over a wired network.

### DESCRIPTION OF VARIOUS EMBODIMENTS

The present invention will be understood and appreciated more fully from the following detailed description taken in conjunction with the following figures:

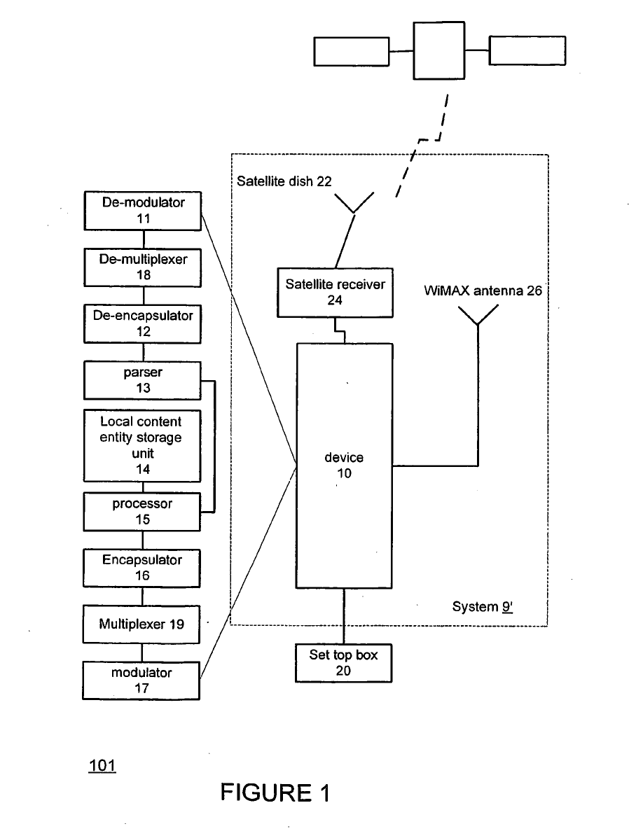

FIG. 1 illustrates a system, according to an embodiment of the invention;

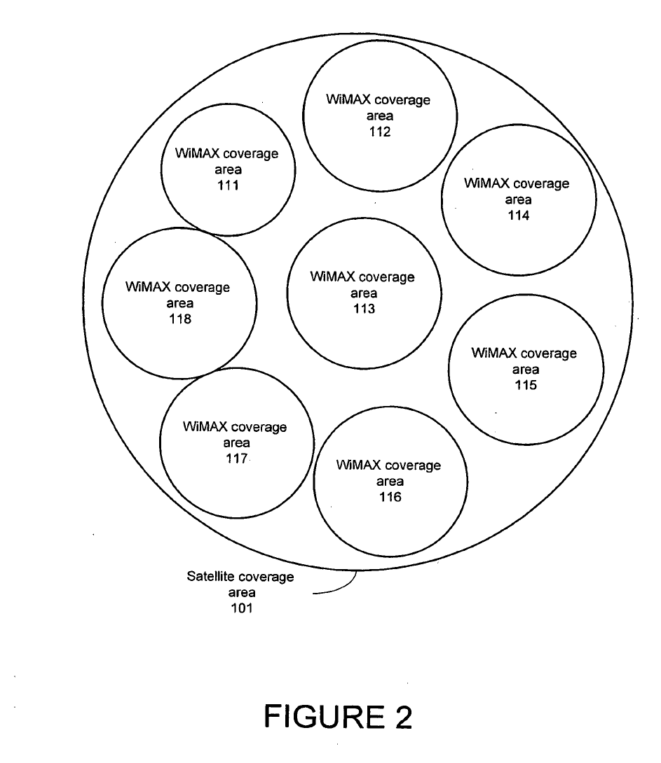

FIG. 2 illustrates multiple coverage areas according to an embodiment of the invention;

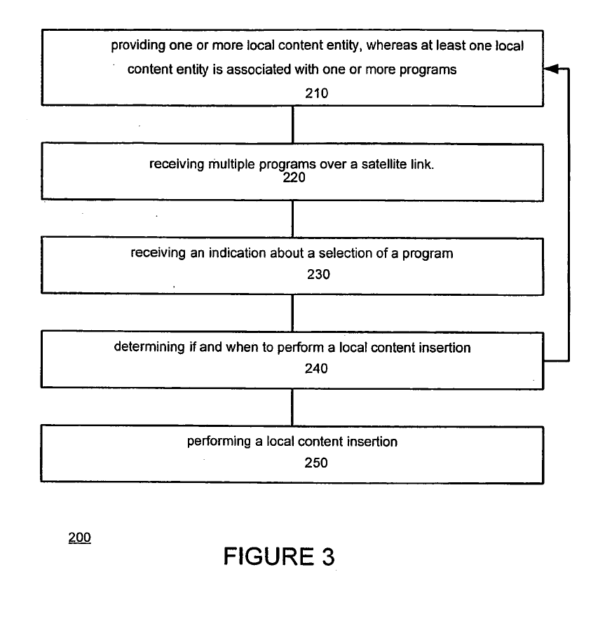

FIG. 3 illustrates a method for local content insertion, according to an embodiment of the invention;

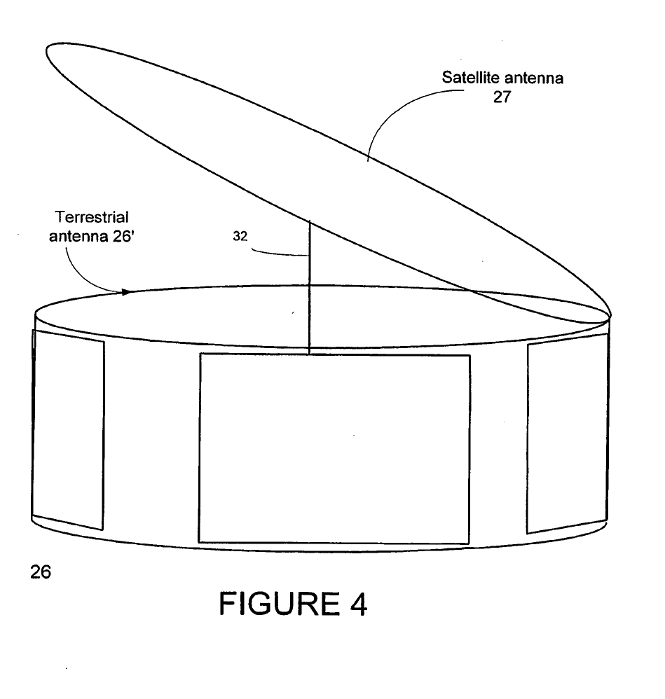

FIG. 4 illustrates a terrestrial antenna and a satellite antenna, according to an embodiment of the invention;

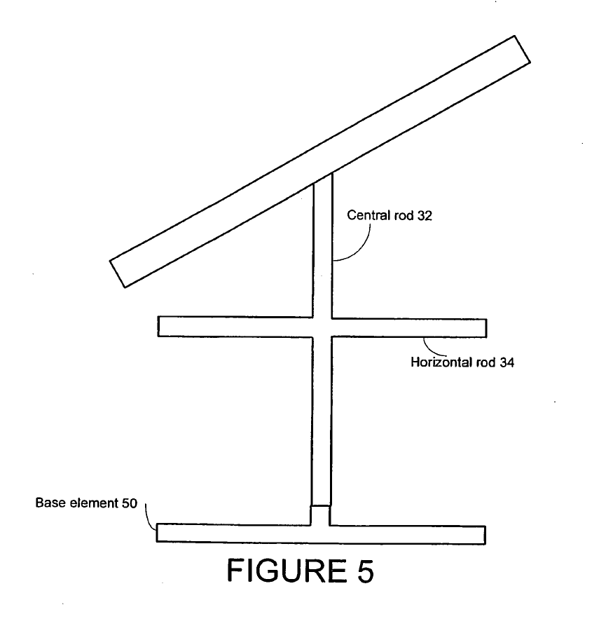

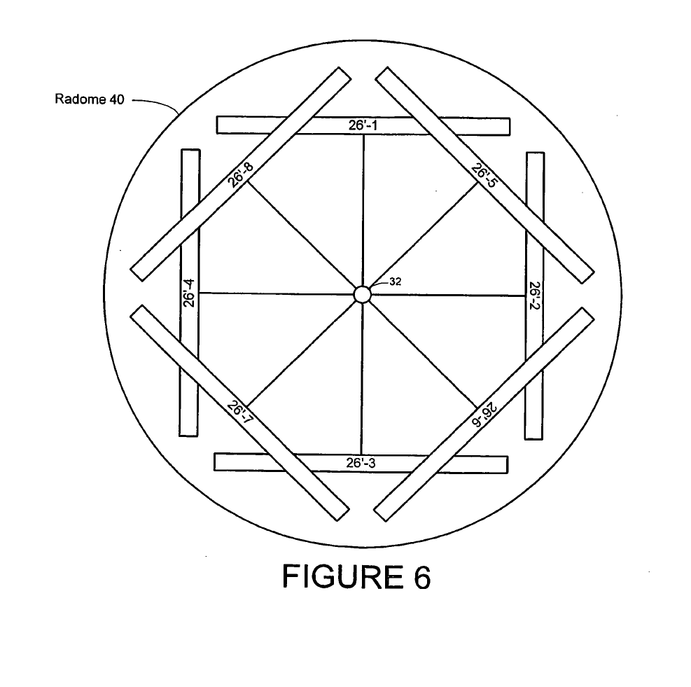

FIGS. 5 and 6 illustrate cross sectional views of an antenna unit, according to an embodiment of the invention; and

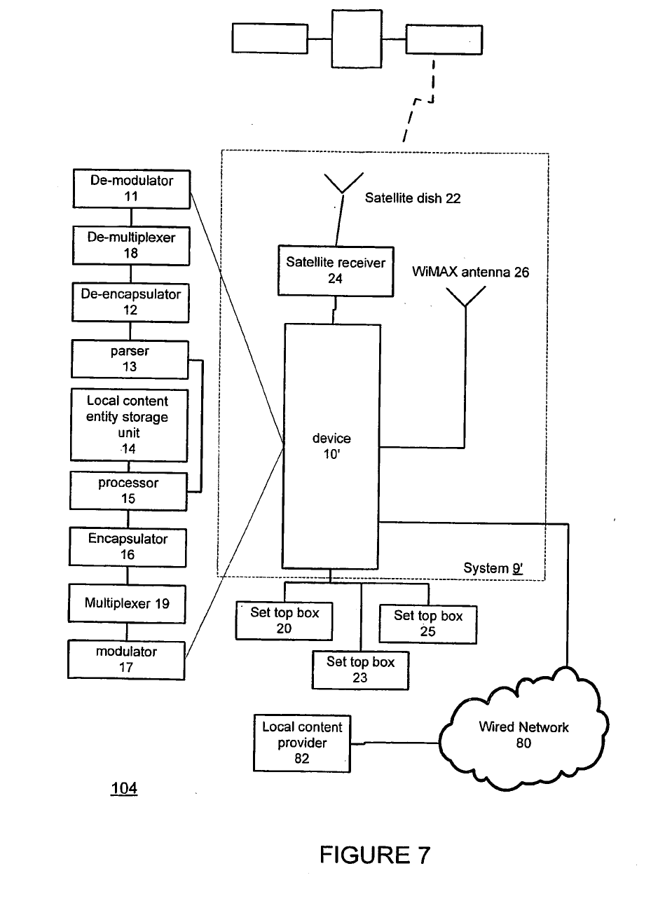

FIG. 7 illustrates a system, according to an embodiment of the invention.

### DETAILED DESCRIPTION OF THE DRAWINGS

This method and device facilitates localized content insertion within a multiplex of programs received over a satellite link.

The following figures illustrate exemplary embodiments of the invention. They are not intended to limit the scope of the invention but rather assist in understanding some of the embodiments of the invention.

According to an embodiment of the invention a satellite reception path provides a multiplex of programs to a device (denoted 10 in FIG. 1). This device 10 also receives local content (conveniently a limited amount of local content) over a WiMAX link or over another link. The other link can be a wireless link or a wired link, can be a broadband link or a narrow band link, and the like.

Conveniently, the local content is associated with one or more program. The device 10 receives an indication about the program that is being outputted from an end used device (such as a set top box) in case of an integrated device it can do it in the same device and if a stored local content is associated with that outputted program then device 10 performs a local content insertion. The timing of the insertion is determined by dedicated signals within the program. Association is according to user defined rules or programming received via the link

Conveniently, by associating local content to certain programs the computational load imposed upon the device 10 is dramatically reduced, and a device that has limited computational resources can handle this task.

According to an embodiment of the invention the local content entities includes multiple commercials, that can be associated with different programs. Each commercial can be relatively short.

According to an embodiment of the invention the local content is inserted in predefined intervals. These intervals are identified in various prior art methods. The local content insertion involves replacing a certain program portion (usually an idle portion) with the local content.

In order to perform local insertion the multiplex of programs received from the satellite (via a satellite tuner or receiver) can be de-modulated and de-capsulated.

Once the local content can be inserted it is provided to the set top box in a format that resembles the formats of signals provided by the satellite. Accordingly, this can require modulation, frequency conversion and the like. In our unit

According to yet another embodiment of the invention the local content is stored in another device (such as but not limited to a PVR) or the same device with PVR functionalities and device 10 can retrieve the local content from that other device, or can perform the task in case of integrated device. In the case of PVR (or large storage device) the commercials and adv. Insertion rules can be received via satellite using std. data carousel technique.

According to a further embodiment of the invention the satellite link is used to convey a dedicated program that transmits local content. Each device can determine whether the local content is aimed to it and store the local content. Conveniently the local content will be associated with area identification information to allow selective reception of the local content.

FIG. 1 illustrates system 9 according to an embodiment of the invention.

System 9 includes device 10, WiMax reception path (that includes at least WiMax antenna 26) and a satellite reception path (including at least a satellite dish 22 and a satellite front end receiver 24). The front-end receiver 24 usually includes a tuner.

The receiver 24 is connected to device 10. Device 10 is connected to end user equipment such as but not limited to a set-top box 20. System 9 and set top box 20 form environment 101.

The set top box 20 provides device 10 an indication about a selected program (for example by sending its PID and optionally its carrier frequency).

Device 10 is connected to a WiMAX antenna 28 and is capable of transmitting and receiving information using a WiMAX link.

Device 10 is also adapted to detect local content insertion locations (for example detecting an advertisement queue signal) and to insert local content.

Device 10 can include a RF chip, a base-band chip and a controller that perform multiple operations such as de-modulation, modulation, de-capsulation, encapsulation, content replacement, and the like.

Conveniently, device 10 includes a de-modulator 11, a de-multiplexer 18, a de-encapsulator 12, a parser 13, a local content entity storage unit 14, a processor 15, an encapsulator 16, a multiplexer 19, and modulator 17.

De-modulator 11 receives the multiplex of programs from satellite receiver 24 and performs a de-modulation such as to extract data from the received symbols. The de-multiplexer 18 selects a selected program (in response to a selection signal provided by processor 15) that is provided to de-encapsulator 12 while the remaining programs of the multiplex of programs are provided to multiplexer 19. The selected program is de-encapsulated by de-encapsulator 12, is being parsed by parser 13 and being provided to processor 15, along with local content stored in local content entity storage unit 14. Processor 15 receives the parsed program and can determine whether to insert a local content entity and when to do so. The timing can be responsive to the timing of predefined intervals within the selected program.

Processor 15 also can perform the insertion and provide a selected program with inserted local content to encapsulator 16 that in turn provides the selected program with the inserted local content to multiplexer 19. Multiplexer 19 provides multiplexes the remaining programs provided by de-multiplexer 18 and the selected program with inserted local content to provide a multiple of programs with inserted local content. This multiplex of programs is provided to modulator 17 that modulated multiplex of programs to modulator 17 that modulates the multiplex of programs according to the format of the input multiplex of programs as received by de-multiplexer 11.

According to another embodiment of the invention the set top box can be of different types, including but not limited to an Internet Protocol (HP) set top box. If the environment includes an IP set top box then various demodulation stages are not required.

FIG. 2 illustrates a satellite coverage area 101 that includes multiple WiMAX coverage areas 111-118. In this configurations at least eight different contents can be provided within the single satellite coverage area. It is noted than more or less than eight WiMAX coverage areas can be included within a single satellite coverage area.

FIG. 3 illustrates a method 200 for local content insertion, according to an embodiment of the invention.

Method 200 starts by stage 210 of providing one or more local content entity, whereas at least one local content entity is associated with one or more programs. The local content entities (such as commercials) can be conveyed over WiMAX links, although this is not necessarily so.

Stage 210 is followed by stage 220 of receiving multiple programs over a satellite link.

Stage 220 is followed by stage 230 of receiving an indication about a selection of a program, conveniently by an end-user. The selected program can be viewed by the user. The selection can be implemented by a remote control, in real time, in advance (for example by preprogramming the set top box to tune to a certain program during certain periods), and the like.

Stage 230 is followed by stage 240 of determining if and when to perform a local content insertion. The determination is conveniently responsive to the program that is associated with the local content entity and to the selected program.

If the determination is positive then the local content insertion occurs during predefined periods (or in response to a predefined signal). Said insertion takes place in stage 250 of performing local content insertion.

If the answer is negative stage 240 is followed by stage 210.

It is noted that stage 210 can be executed in parallel to other stages of method 200.

It is noted that method 200 can be applied for providing few selected programs that include selected local content. This can occur when a device such as device 10 is connected via a domestic network to few end—user devices. Accordingly, if different end user devices output different programs that few different programs are selected. Each program can be associated with a different local content. Thus, the local content insertion can be executed in parallel for few different selected programs. Conveniently, a multiplex of programs that includes few selected programs, each including local content, will be provided to these few end user devices.

According to another embodiment of the invention the method can include generating an end user profile or receiving an end user profile information. The end user profile information can reflect viewing patters of the end user, as well as socio-economical information, billing information and the like. The socio-economical information as well as billing information is usually provided from a satellite or cable operator, but this is not necessarily so.

A selection of local content can be also responsive to the end user profile. This end user profile can be used to select between multiple local content associated with a single program.

Accordingly stage 230 can include selecting local content entity in response to the selected program and end user profile.

FIG. 4 illustrates a terrestrial antenna 26′ and a satellite antenna 27, according to an embodiment of the invention. FIGS. 5 and 6 illustrate cross sectional views of an antenna unit 21.

Satellite antenna (also referred to as satellite WiMax antenna) 27 is used for receiving information over the satellite link. It conveniently points towards the corresponding Geostationary satellite through manual, mechanical, or electrical steering, and using either open loop, or closed loop adjustment. The inventors use a fixed satellite antenna oriented at an angle of 40 degrees such as to receive transmissions from a satellite beam that spans between 23.3 and 59.9 degrees. The terrestrial WiMax antenna (also referred to as terrestrial antenna) 22 is conveniently a WiMAX multi sector antenna.

Conveniently, satellite antenna 27 is adapted to receive right hand circularly polarized radiation and left band circularly polarized radiation over a satellite link. Conveniently, satellite antenna 27 is oriented in relation to an imaginary vertical axis (illustrated by dashed line 19) that is substantially parallel to multiple elements of the terrestrial multiple sector antenna.

Conveniently, the satellite antenna 27 is connected to a structural element 30 that includes a central rod 32 as well as multiple horizontal rods 34 that connect the central rod 32 to each of the elements 26-I of the terrestrial multiple sector antenna 26. The central rod 32 can be pivotally mounted to base element 33.

The inventors used a terrestrial antenna 26′ that had eight antenna elements. Four antenna elements were oriented at 0, 90, 226 and 270 degrees, while four antennal elements were oriented at 45, 135, 215 and 305 degrees.

It is noted that the number of antenna elements, the shape of each antenna element, the angular range covered by each antenna element as well as the relative position of the antenna elements in relation to each other can differ from those illustrated in FIGS. 5 and 6.

For example, a terrestrial antenna can include four antenna elements with 90 degrees between them on one level, and another four element antennas positioned on another level, wherein the four other antenna elements are oriented by 45 degrees in relation to the first four antennas.

The beam forming can be such that each element is used solely for transmission/reception to one of the eight directions. The beam forming can be such that two or more elements are combined in phase to produce a radiation pattern to each of the eight directions. I.e. to create a radiation pattern to a selected direction, two or more elements will be used, combined together in phase. To create a radiation pattern to another selected directions, a combination of other two or more elements will be used. The terrestrial antenna is also supporting omni directional beam, by combining all the terrestrial antenna elements together.

Conveniently, the satellite antenna 22, the terrestrial antenna 26 are surrounded (or at least partially surrounded) by radome 40.

Conveniently, the radome 40 is fixed to the structural element 30, so that when the radome 40 rotates the structural element (as well as antennas 22 and 26) rotate.

The structural element 30 and/or as well as radome 40 can be pivotally connected to a base element 50. The base element 50 can be fixed to a rooftop or another stationary element.

According to an embodiment of the invention location information is printed on an external surface of the radome 40. Different location information can be printed on different positions (that correspond to different angles in relation to an imaginary center of the radome) of radome 40, thus allowing to direct the antaean unit 21 towards a required direction (that corresponds to a location of the satellite) by rotating the radome until a location indication printed on radome 40 is directed towards a predefined direction (that can be determined by using, for example, a compass).

The location information can include the name of cities, states, countries and the like (or longitude, altitude coordinates). The location information printed on a radome sold in New York can differ from the location information printed on a radome sold in Los Angeles, but this is not necessarily so. According to another embodiment of the invention the same location information can be used in different locations.

Antenna unit 21 defines multiple reception (an/or transmission) paths. Satellite antenna 26 can receive both right hand circularly polarized radiation and left hand circularly polarized radiation thus can define two radiation paths. Each antenna element (sector) 26′-I of terrestrial antenna 26′ can define its own reception paths. It is noted that the radiation received by two or more antenna elements 26-I can be combined prior to being received by other elements (such as a receiver front end) or system 10. It is further notes that satellite antenna 27 as well as terrestrial antenna 26′ can be used for transmitting information. Multiple antenna elements 26-I of terrestrial antenna 26 can transmit the same information.

FIG. 4 illustrates system 9′ according to another embodiment of the invention.

System 9′ includes device 10′, WiMax reception path (that includes at least WiMax antenna 26′ and satellite antenna 27) and a satellite reception path (including at least a satellite dish 22 and a satellite front end receiver 24). The front-end receiver 24 usually includes a tuner.

Satellite dish 22 is adapted to receive a multiplex of programs. Satellite antenna 27 is much smaller and is adapted to receive data.

Satellite receiver 24 is connected to device 10′. Device 10′ is connected to end user equipment such as but not limited to a set-top boxes 20, as and 25. System 9′ and set top boxes 20, 23 and 25 form environment 107.

FIG. 7 illustrates a wired network 80 that is connected to device 10′ and to local content insertion provider 82 that is connected to wired network 80.

Device 10′ differs from device 10 of FIG. 1 by its ability to process few selected programs and to add local content to each of these few selected programs.

Device 10 as well as device 10′ are connected to end user devices via a short-range network that can include one or more cables that are usually installed within a single building. In a typical scenario device 10′ an antenna reception unit that includes satellite antenna 22 and WiMax antenna 26 are installed on the building that includes the end user devices.

The processing of multiple programs can be executed in a serial manner but is usually executed in a parallel manner. De-multiplexer 18 outputs few selected channels, each selected channel is parsed and local content information is added. These few selected programs (now including local content information) are multiplexed with the other non-selected programs to form a multiplex of programs that is modulated and provided to the few end user devices.

Device 10′ is adapted to service few (for example up to 3 or 5 end user devices) in order to maintain simple and cost effective.

Device 10′ can also allow end-user devices to exchange data over wired network 80. Wired network 80 can be connected to the Internet. Socio-economical information database as well as to a billing information database. These databases can provide socio-economical information and billing information that can assist in generating an end-user profile. The end user profile can also include viewing statistics. This profile can assist in determining which local content to send to device 10′ and can assist device 10′ in selecting which local content entity to associate with a certain program being outputted from a certain end user device.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A system comprising: a processor coupled to a parser, wherein the parser is adapted to parse a selected program out of a multiplex of programs provided to the system over a satellite reception path; wherein the processor is adapted determine whether to insert local content to the selected program and in response to the determination insert the local content; wherein the system is further adapted to provide the selected program that comprises the local content to an end user system.

2. The system according to claim 1 wherein the system comprises a local content storage unit adapted to store a limited amount of local content.

3. The system according to claim 1 wherein the system is adapted to receive the local content over a link that differs from the satellite link.

4. The system according to claim 1 wherein the system is adapted to be coupled to a WiMax antenna and is adapted to receive local content from the WiMax antenna.

5. The system according to claim 1 wherein the system is adapted to receive information representing a program being outputted from an end-user system and in response select this outputted program as the selected system.

6. The system according to claim 1 wherein the system comprises a modulator adapted to send to a limited number of end user systems a multiplex of programs that comprises the selected program and the inserted local content in a format that corresponds to a format of signals provided by a satellite that is being received by the satellite reception path.

7. The system according to claim 1 wherein the system is adapted to store local content included within a dedicated satellite program.

8. The system according to claim 1 wherein the system is adapted to store local content included within a dedicated satellite program that is associated with an area indication.

9. The system according to claim 1 further adapted to exchange data over a wired network.

10. The system according to claim 1 further comprising a satellite reception path and a terrestrial antenna.

11. A method comprising: receiving multiple programs over a satellite link; determining whether to perform a local content insertion such as to insert a local content entity to a selected program being outputted by an end user device; inserting the local content entity in response to the determination; and providing the selected program that comprises the inserted local content entity to the end user device.

12. The method according to claim 11 further comprising receiving the local content entity and storing the local content entity.

13. The method according to claim 11 further comprising receiving the local content entity over a link that differs from a satellite reception link.

14. The method according to claim 11 further comprising receiving the local content entity from a WiMax antenna.

15. The method according to claim 11 wherein the method comprises formatting the selected program that comprises the inserted local content according to a format that corresponds to a format of the selected program over the satellite link.

16. The method according to claim 11 further comprising storing the local content entity that is included within a dedicated satellite program.

17. The method according to claim 1further comprising storing the local content entity that is included within a dedicated satellite program.

18. The method according to claim 1further comprising storing the local content entity that is included within a dedicated satellite program that is associated with an area indication.

19. The method according to claim 11 further comprising exchanging data over a wired network.
